(19) United States
(12) Patent Application Publication
(10) Pub. No.: US 2025/0240726 A1
(43) Pub. Date: Jul. 24, 2025

(54) METHOD AND APPARATUS FOR TRANSCEIVER ADAPTATION FOR NETWORK ENERGY SAVING

(71) Applicant: MEDIATEK INC., Hsinchu City (TW)

(72) Inventors: Chien-Chun CHENG, Hsinchu City (TW); Wei-De WU, Hsinchu City (TW); Yi-Ju LIAO, Hsinchu City (TW); Cheng-Hsun LI, Hsinchu City (TW)

(21) Appl. No.: 18/855,503

(22) PCT Filed: May 30, 2023
(86) PCT No.: PCT/CN2023/097114

§ 371 Date: Oct. 9, 2024

Related U.S. Application Data
(60) Provisional application No. 63/350,919, filed on Jun. 10, 2022.

(51) Int. Cl. H04W 52/02; H04L 5/00; H04W 24/10

(52) U.S. Cl. CPC H04W 52/0235; H04L 5/0048; H04W 24/10

(57) ABSTRACT

Various solutions for transceiver adaptation for network energy saving with respect to user equipment and network apparatus in mobile communications are described. An apparatus may receive an indication of spatial element adaptation from a network node. The apparatus may determine whether to transmit a channel state information-reference signal (CSI-RS) report based on the indication of spatial element adaptation.

### CROSS REFERENCE TO RELATED PATENT APPLICATION(S)

The present disclosure is part of a non-provisional application claiming the priority benefit of U.S. Patent Application No. 63/350,919, filed 10 Jun. 2022, the content of which herein being incorporated by reference in its entirety.

### TECHNICAL FIELD

The present disclosure is generally related to mobile communications and, more particularly, to transceiver (TRX) adaptation for network energy saving with respect to user equipment (UE) and network apparatus in mobile communications.

### BACKGROUND

Unless otherwise indicated herein, approaches described in this section are not prior art to the claims listed below and are not admitted as prior art by inclusion in this section.

The energy consumption may have become a crucial part for the operating expense (OPEX) of the operators. The energy consumption on the mobile networks may account for about 23% of the total operator cost. Most of the energy consumption may come from the radio access network (particularly the active antenna unit (AAU) of the radio access network) with data centers and fiber transport accounting for a share.

In a current network deployment, when the physical resource block (PRB) utilization is less than 10% and the number of user equipments (UEs) in the radio resource control (RRC) connected mode is less than 5, the network node may mute some transceiver (TRX) chains for energy saving. When the PRB utilization is more than 20%, or the number of the UE in the RRC connected mode are more than 10, the network node may enable the muted TRX chains.

The semi-static network energy-saving method may be transparent to UE when the network node mutes some TRX chains or enable the TRX chains. However, the semi-static network energy saving method cannot track the dynamic traffic arrival immediately. As a result, it may lead to extra transmission delay on some transmission time intervals (TTIs) with large traffic buffer or poor channel conditions. The RRC reconfiguration may be needed to adapt to the network change.

Accordingly, how to reduce the transmission delay and transmission error when the TRX change occurs in the network node becomes an important issue for the newly developed wireless communication network. Therefore, there is a need to provide proper schemes and designs for the TRX change.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to TRX adaptation for network energy saving in mobile communications. It is believed that the above-described issue would be avoided or otherwise alleviated by implementing one or more of the proposed schemes described herein.

In one aspect, a method may involve an apparatus receiving an indication of spatial element adaptation from a network node. The method may also involve the apparatus determining whether to transmit a channel state information-reference signal (CSI-RS) report based on the indication of spatial element adaptation.

In another aspect, an apparatus may involve a transceiver which, during operation, wirelessly communicates with at least one network node. The apparatus may also involve a processor communicatively coupled to the transceiver such that, during operation, the processor performs following operations: receiving, via the transceiver, an indication of spatial element adaptation from the network node; and determining whether to transmit a channel state information-reference signal (CSI-RS) report based on the indication of spatial element adaptation.

It is noteworthy that, although description provided herein may be in the context of certain radio access technologies, networks and network topologies such as 5^{th} Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIOT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of an indication of spatial element adaptation under schemes in accordance with implementations of the present disclosure.

FIG. 2 is a diagram depicting an example scenario of a process associated with the indication of spatial element adaptation under schemes in accordance with implementations of the present disclosure.

FIG. 3 is a diagram depicting an example scenario of a CSI report (re) configuration under schemes in accordance with implementations of the present disclosure.

FIG. 4 is a diagram depicting an example scenario of signaling mechanisms of CSI reporting types under schemes in accordance with implementations of the present disclosure.

FIG. 5 is a diagram depicting an example scenario of a SP CSI-RS (de) activation under schemes in accordance with implementations of the present disclosure.

FIG. 6 is a diagram depicting an example scenario of signaling mechanisms of CSI resources with different CSI resource types under schemes in accordance with implementations of the present disclosure.

FIG. 7 is a diagram depicting an example scenario of support status of CSI reporting types under schemes in accordance with implementations of the present disclosure.

FIG. 8 is a diagram depicting an example scenario of a SP CSI-RS/CSI-IM resource set activation and deactivation MAC-CE under schemes in accordance with implementations of the present disclosure.

FIG. 9 is a diagram depicting an example scenario of a SP ZP CSI-RS resource set activation and deactivation MAC-CE under schemes in accordance with implementations of the present disclosure.

FIG. 10 is a diagram depicting an example scenario of a SP CSI reporting on PUCCH activation and deactivation MAC-CE under schemes in accordance with implementations of the present disclosure.

FIG. 11 is a diagram depicting an example scenario of a SCell activation and deactivation under schemes in accordance with implementations of the present disclosure.

FIG. 12 is a diagram depicting an example scenario of a SCell activation and deactivation MAC-CE of one octet under schemes in accordance with implementations of the present disclosure.

FIG. 13 is a diagram depicting an example scenario of a SCell activation and deactivation MAC-CE with one octet Cᵢ field under schemes in accordance with implementations of the present disclosure.

FIG. 14 is a diagram depicting an example scenario of a BWP change with micro-active-dormant (MAD)-BWP ID under schemes in accordance with implementations of the present disclosure.

FIG. 15 is a diagram depicting an example scenario of RRC IEs under schemes in accordance with implementations of the present disclosure.

FIG. 16 is a diagram depicting an example scenario of the powerContolOffsetSS and the powerContolOffset under schemes in accordance with implementations of the present disclosure.

FIG. 17 is a diagram depicting an example scenario of a flow chart associated with the MAD BWP under schemes in accordance with implementations of the present disclosure.

FIG. 18 is a diagram depicting an example scenario of a layer 3 filtering under schemes in accordance with implementations of the present disclosure.

FIG. 19 is a diagram depicting an example scenario of a PDSCH repetition under schemes in accordance with implementations of the present disclosure.

FIG. 20 is a block diagram of an example communication system in accordance with an implementation of the present disclosure.

FIG. 21 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transceiver (TRX) adaptation for network energy saving in mobile communications. According to the present disclosure, a number of possible solutions may be implemented separately or jointly. That is, although these possible solutions may be described below separately, two or more of these possible solutions may be implemented in one combination or another.

The active antenna architecture typically may have a plurality of antenna elements and the number of antennas may be greater than the number of TRXs. This means that each TRX may be connected to multiple antenna elements. Each transceiver may be connected to a single column of antenna elements to provide basic horizontal beamforming. However, logical antenna ports may be specified rather than physical antenna elements in 3^{rd} Generation Partnership Project (3GPP) Specifications. Specific transmissions may use specific antenna ports which are mapped onto one or more physical antenna elements. For example, it is assumed that there are two antenna ports, one physical downlink shared channel (PDSCH) and its demodulation reference signal (DMRS) may be associated with one antenna port and another PDSCH and its DMRS may be associated with the other antenna port. The user equipment (UE) may not require knowledge of which physical antenna elements and TRXs are used for the two transmissions.

In addition, there may be a one-to-many mapping between the antenna ports and the physical antenna elements. This mapping may be beneficial for beamforming that uses multiple physical antenna elements to direct the downlink transmissions towards a specific UE.

The 5G New Radio (NR) may support the long-term channel measurements. The UE may derive long-term channel quality indicator (CQI), layer 1 signal to interference plus noise ratio (L1-SINR), or L1-reference signal received power (RSRP) values by measuring multiple synchronization signal block (SSB) or channel state information-reference signal (CSI-RS) occasions. The number of SSBs or CSI RSs may be determined based on the UE implementation.

In the 3GPP NR Specifications, if the radio resource control (RRC) parameter timeRestrictionForChannelMeasurements in CSI-ReportConfig is set to “notConfigured”, the UE may derive the channel measurements based on one or multiple SSB or non-zero-power (NZP) CSI-RS transmission occasions before the configured CSI reference resource which is associated with the CSI resource setting. The channel measurements may be used for computing the L1-RSRP value, L1-SINR value, or CQI value reported in uplink slot.

If the network node turns off some TRX chains for network energy savings (NWES) during the long-term channel measurement, the measurement and its CSI report may be invalid due to the following reasons. One reason may be that the number of configured antenna ports has been reduced due to fewer active TRX chains. Another reason may be that the CSI has been changed due to using a different TRX chain setting.

When the TRX setting has been changed, the CSI measurement which needs to be performed before the TRX change may become useless for the network node to perform link adaptation or beam management. As a result, the CSI report related to the useless CSI measurement may not be needed because the CSI report comprises the measured values before the TRX has been changed.

The 5G NR may also support short-term channel measurements. The UE may derive CQI, L1-SINR, or L1-RSRP values by measuring the most recent SSB or CSI-RS occasion (e.g., the UE may only measure the most recent CSI-RS) in an event that the RRC parameter timeRestrictionForChannelMeasurements in CSI-ReportConfig is set to “Configured.”

However, if the TRX settings change between the most recent SSB (or CSI-RS) and the CSI report, the measurement on the most recent SSB or CSI-RS may become useless, and the CSI report may not be needed.

After the CSI report (re) configuration, the serving cell activation, the bandwidth part (BWP) change, or the activation of semi-persistent (SP)-CSI, the UE may report a CSI report only when the UE receives at least one of CSI-RS transmission occasion for channel measurement and the CSI-RS and/or CSI-interference measurement (IM) occasion for interference measurement before the CSI reference resource. Otherwise, the UE may drop the CSI report.

However, there is no TRX change indication in the current technologies. Therefore, when the network changes the TRX settings, the UE may waste energy and resource to perform the redundant 25 CSI measurement and reporting.

Accordingly, the present disclosure proposes some solutions to resolve the issues.

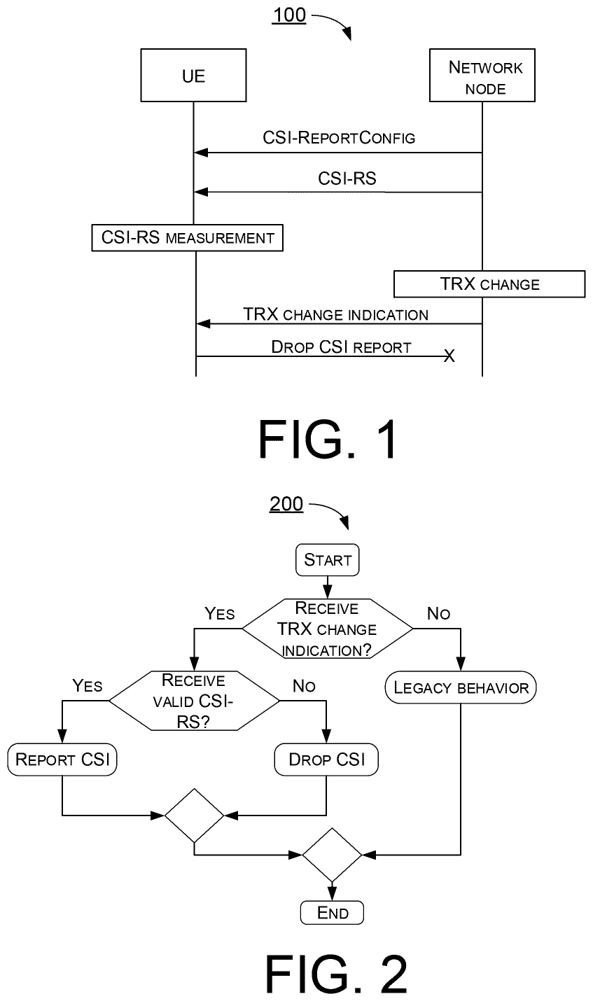

FIG. 1 illustrates an example scenario 100 of an indication of spatial element adaptation under schemes in accordance with implementations of the present disclosure. Scenario 100 involves a network node (e.g., a macro base station and multiple micro base stations) and a UE, which may be a part of a wireless communication network (e.g., an LTE network, a 5G/NR network, an IoT network or a 6G network). Referring to FIG. 1, the UE may receive an indication of spatial element adaptation (e.g., a TRX-change indication) from the network node. Then, the UE may determine whether to transmit a CSI-RS report (or CSI report) based on the indication of spatial element 35 adaptation. In an example, if the UE receives at least one CSI-RS or CSI-IM before receiving the indication of spatial element adaptation, the UE may drop a CSI report associated with the received CSI-RS or CSI-IM. In another example, if the UE receives at least one CSI-RS or CSI-IM after receiving the indication of spatial element adaptation, and the received CSI-RS or CSI-IM is not later than the configured CSI reference resource, the UE may report a CSI report associated with the received CSI-RS or CSI-IM. In another example, if the UE receives at least one CSI-RS or CSI-IM 40 after receiving the indication of spatial element adaptation, but the received CSI-RS or CSI-IM is later than the configured CSI reference resource, the UE may drop the CSI report associated with the received CSI-RS or CSI-IM. The indication of spatial element adaptation may indicate whether a TRX change occurs.

The spatial element indicated by the indication of spatial element adaptation may comprise at least one of an antenna element, a transceiver unit (TxRU), an antenna panel, and a logical antenna port.

In some implementations, the UE may further adapt or reconfigure a configured CSI-RS configuration based on the indication of spatial element adaptation. The adapted or reconfigured configured CSI-RS configuration may comprise dynamic or semi-persistent ON or OFF of a CSI-RS or adapted number of spatial elements or ports.

In some implementations, the UE may receive the indication of spatial element adaptation from the network node through a RRC signaling, a media access control (MAC) control element (MAC-CE) or downlink control information (DCI). In addition, the indication of spatial element adaptation may be per UE, per cell group, per cell, or per BWP.

In some implementations, the indication of spatial element adaptation may comprises at least one of an information field which is used to indicate whether the TRX chains are changed, a plurality of information blocks, a cell identity (ID), a bandwidth part (BWP) ID, a transceiver (TRX) configuration (TRX-config) ID, a CSI report configuration ID, a CSI resource configuration ID, a CSI-RS configuration or a CSI-RS reconfiguration.

The information field which is used to indicate whether the TRX chains are changed may comprise 1 bit. When the bit is set to “0”, it may mean that the TRX chains have no change. When the bit is set to “1”, it may mean that TRX chains have a change.

The multiple information blocks may provide for multiple UEs. Each information block of is for a single UE. The UE may receive an information block ID through RRC from network node. Then, the UE may use the information block ID to find the corresponding information block when the UE receive the indication of spatial element adaptation.

The Cell ID may indicate an activation or deactivation of a secondary cell (SCell). When the Cell ID is set to 1, it may mean that the SCell should be activated. When the Cell ID is set to 1, it may mean that the SCell should be deactivated. In another embodiment, the Cell ID may be used to indicate which cell TRX change associates with the Cell ID.

The BWP ID may be used to indicate that the BWP should be active. i.e., the BWP ID may be used to indicate an active BWP. The rest of the BWPs should be inactive. In another embodiment, the BWP ID may be used to indicate which BWP TRX change associates with the BWP ID.

The TRX-config ID may be used to indicate a TRX setting pattern (or spatial adaptation pattern). The TRX setting pattern may include the number of active transmit (TX) chains, the number of active reception (RX) chains, or the number of active transceiver TRXs. The TRX setting pattern may comprise transmission configuration indicator (TCI) states that the UE may assume Quasi Co-Location (QCL) between channels and signals with QCL Type D: {Spatial Receiver Parameters}. The UE may determine whether spatial receiver parameters need a change when the UE receive the indication that includes QCL information.

In addition, the TRX-config ID may be used to indicate a logical antenna port setting. The logical antenna port setting may indicate the maximum number of DL antenna ports for CSI-RS, SSB, DMRS, tracking reference signal (TRS), or PDSCH. The logical antenna port setting may also indicate the maximum number of UL antenna ports for sounding reference signal (SRS), DMRS, TRS, or PUSCH. If the maximum number of DL or UL antenna ports is smaller than the configured antenna ports for transmission or reception, the UE may skip the reception or drop the transmission.

The CSI report configuration ID may be used to indicate a CSI report configuration. The CSI report configuration may belong to a CSI report list configured through RRC. The CSI report list may comprise multiple CSI report configurations. The indicated CSI report configuration in the list CSI report list may be activated, and the previous or the rest CSI report configurations in the list CSI report list may be deactivated. In an example, the CSI report configuration may associate with one or more spatial adaptation patterns. In another example, the CSI report configuration may comprise a plurality of CSI report sub-configurations, and each CSI report sub-configuration may associate with one spatial adaptation pattern.

The CSI resource configuration ID may be used to indicate a CSI resource configuration which associates with a CSI report configuration. The CSI resource configuration may be associated with the TRX-config ID, the BWP ID, or the Cell ID which the UE using to determine the resource elements (REs) to perform CSI measurement after a TRX change. The CSI resource configuration may belong to a CSI resource set configured by the network node through the RRC.

In some implementations, the indication of spatial element adaptation may comprises at least one of a CSI-RS resource, a CSI-RS resource set and a CSI-RS resource setting, and wherein the at least one of the CSI-RS resource, the CSI-RS resource set and the CSI-RS resource setting associates with one or more spatial adaptation patterns.

The spatial adaptation pattern may comprise a set of parameters which are used to determine a spatial element adaptation. In addition, the set of parameters may comprise at least one of spatial domain parameters, spectral domain parameters, and temporal domain parameters.

FIG. 2 illustrates an example scenario 200 of a process associated with the indication of spatial element adaptation under schemes in accordance with implementations of the present disclosure. Scenario 200 involves a network node (e.g., a macro base station and multiple micro base stations) and a UE, which may be a part of a wireless communication network (e.g., an LTE network, a 5G/NR network, an IoT network or a 6G network). Referring to FIG. 2, the UE may determine whether the indication of spatial element adaptation is received from the network node. If the UE receives the indication of spatial element adaptation from the network node, the UE may further determine whether a CSI-RS received after the TRX change indicated in the indication of spatial element adaptation is a valid CSI-RS (e.g., the received CSI-RS is not later than the CSI reference resource). If the CSI-RS is a valid CSI-RS, the UE may transmit the CSI report associated with the received CSI-RS to the network. If the CSI-RS is not a valid CSI-RS, the UE may drop the CSI report associated with the received CSI-RS.

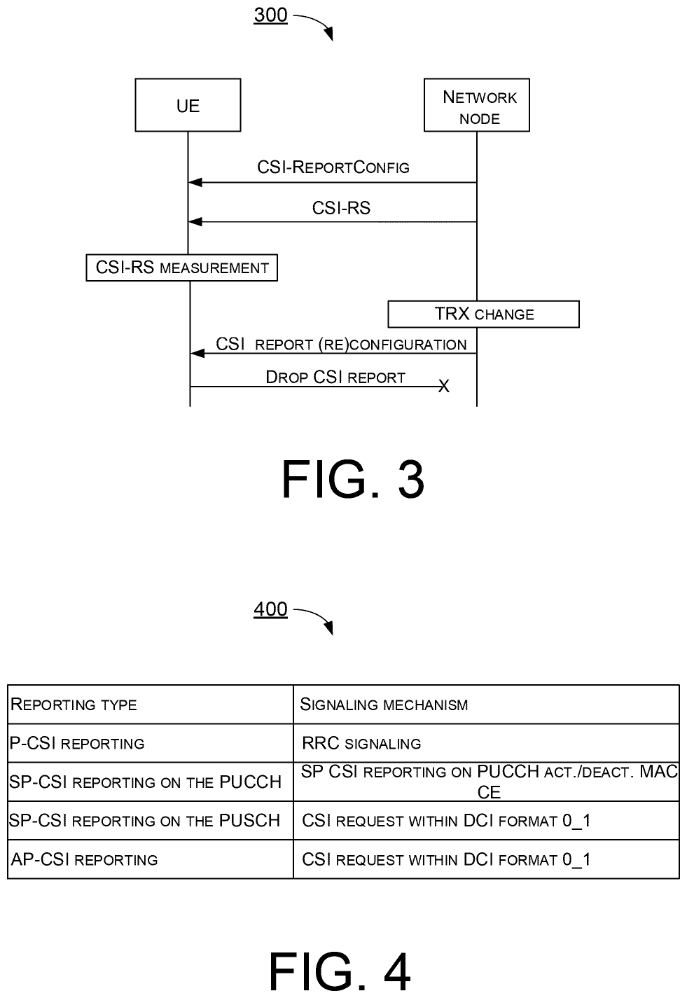

FIG. 3 illustrates an example scenario 300 of a CSI report (re) configuration under schemes in accordance with implementations of the present disclosure. Scenario 300 involves a network node (e.g., a macro base station and multiple micro base stations) and a UE, which may be a part of a wireless communication network (e.g., an LTE network, a 5G/NR network, an IoT network or a 6G network). Referring to FIG. 3, after a TRX change occurs in the network node, the UE may receive a CSI report (re) configuration from the network node through RRC. The UE may determine whether to drop a CSI report based on the CSI report (re) configuration. The processing delay for RRC reconfiguration may be 10 milliseconds (ms).

The UE may receive a CSI report configuration ID through L1 signaling, e.g., a DCI format or a MAC-CE command. The DCI format or MAC-CE command may indicate a CSI report configuration from a CSI report configuration set configured by network before the TRX change.

After the CSI report (re) configuration has been applied, the UE may report a CSI report only when the UE receives at least one of CSI-RS transmission occasion for channel measurement and CSI-RS and/or CSI-IM occasion for interference measurement and the received CSI-RS and/or CS-IM is not later than CSI reference resource. Otherwise, the UE may drop the CSI report.

The UE may determine whether the CSI report (re) configuration has been applied based on at least one of following conditions. In an example, the condition may be that the UE has transmitted an RRC message corresponding to the CSI report (re) configuration when the CSI report (re) configuration is received through RRC. In another example, the condition may be that the UE has transmitted a hybrid automatic repeat request (HARQ)-ACK corresponding to the CSI report (re) configuration after a processing delay of 3 ms when the CSI report (re) configuration is received through the MAC-CE. In another example, the condition may be that the UE has received a DCI format after a processing delay of 10 orthogonal frequency division multiplexing (OFDM) symbols.

FIG. 4 illustrates an example scenario 400 of signaling mechanisms of CSI reporting types under schemes in accordance with implementations of the present disclosure. Scenario 400 involves a network node (e.g., a macro base station and multiple micro base stations) and a UE, which may be a part of a wireless communication network (e.g., an LTE network, a 5G/NR network, an IoT network or a 6G network). Referring to FIG. 4, for periodic CSI (P-CSI) reporting, the signaling mechanism may be that the P-CSI may be activated or deactivated through a RRC signaling. For semi-persistent CSI (SP-CSI) reporting on the physical uplink control channel (PUCCH), the signaling mechanism may be that the SP-CSI reporting on PUCCH may be activated or deactivated through a MAC-CE. For SP-CSI reporting on the physical uplink shared channel (PUSCH), the signaling mechanism may be that the SP-CSI reporting on PUSCH may be activated or deactivated through a CSI request with DCI format 0_1. For aperiodic CSI (AP-CSI) reporting, the signaling mechanism may be that the AP-CSI reporting may be activated or deactivated through a CSI request with DCI format 0_1.

In some implementations, for the SP-CSI reporting on the PUSCH, after a TRX change, the UE may receive the CSI request field in a DCI scrambled with SP-CSI-radio network temporary identity (RNTI) to deactivate or activate one of the trigger states for the SP-CSI reporting on PUSCH. A set of the trigger states may be configured by the network through the RRC signaling.

When the UE receives the CSI request field that activates one of the trigger states, it may be assumed that the UE receives an RRC IE NWES-switch which is set to “on”. In the implementation, the UE may autonomously deactivate the rest of the trigger states configured by CSI-SemiPersistentOnPUSCH-TriggerStateList.

In some implementations, for the SP-CSI reporting on the PUCCH, the PUCCH resource used for transmitting the CSI report may be configured by reportConfigType. The SP-CSI reporting on the PUCCH may be deactivated or activated by a deactivation command or activation command through a MAC-CE or a new common DCI. The MAC-CE or the new common DCI may be used to select one of the SP-CSI reporting settings for the UE using the selected SP-CSI reporting on the PUCCH.

In some implementations, for the P-CSI reporting, the P-CSI reporting may be deactivated or activated through a MAC-CE or a new common DCI. If the UE receives the MAC-CE or the new common DCI, the UE may suspend the P-CSI reporting or skip one CSI report based on the MAC-CE or the new common DCI.

The new common DCI may provide a bit map that enables activation and deactivation through the single DCI. For example, the field of the new common DCI may set to 1 to indicate that that the corresponding SP-CSI report configuration should be activated, and the field of new common DCI may be set to 0 to indicate that the corresponding SP CSI report configuration should be deactivated.

The new common DCI may include multiple information blocks, Cell ID, BWP ID, CSI reporting configuration set ID, or CSI reporting configuration ID.

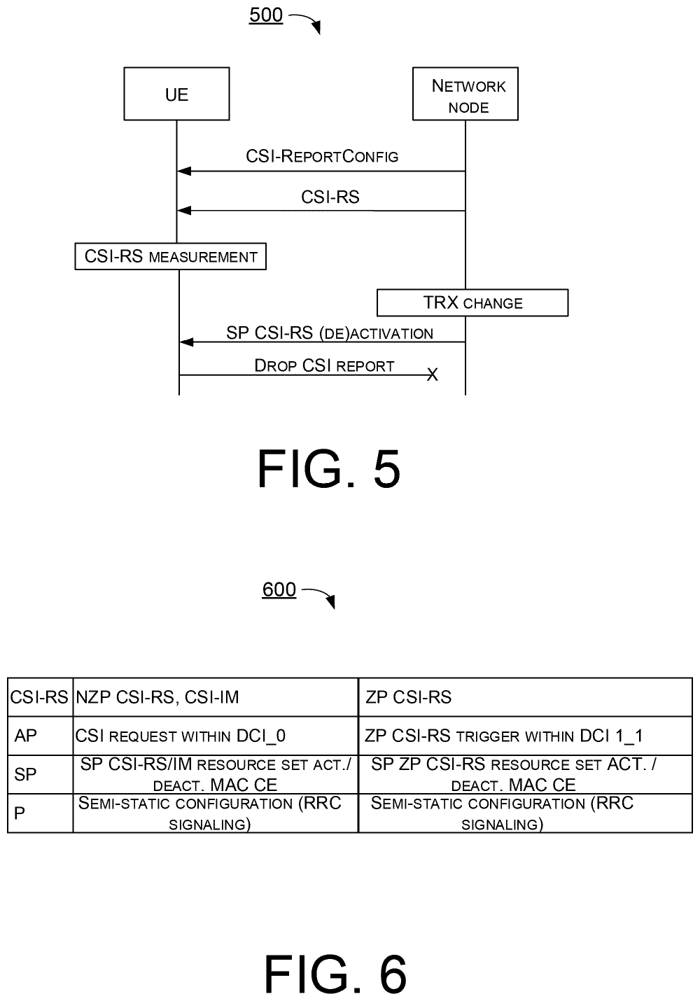

FIG. 5 illustrates an example scenario 500 of a SP CSI-RS (de) activation under schemes in accordance with implementations of the present disclosure. Scenario 500 involves a network node (e.g., a macro base station and multiple micro base stations) and a UE, which may be a part of a wireless communication network (e.g., an LTE network, a 5G/NR network, an IoT network or a 6G network). Referring to FIG. 5, after a TRX change occurs in the network node, the UE may receive an indication associated with a deactivation or an activation of the SP-CSI resource. After receiving the indication associated with the deactivation or activation of the SP-CSI resource, the UE may report a CSI report only when the UE receives at least one of the CSI-RS transmission occasion for channel measurement and the CSI-RS or CSI-IM occasion for interference measurement, and the CSI-RS or CSI-IM is not later than CSI reference resource. Otherwise, the UE may drop the CSI report.

The indication associated with the deactivation or the activation may be transmitted through a MAC-CE command for which the UE requiring to feedback a HARQ-ACK.

FIG. 6 illustrates an example scenario 600 of signaling mechanisms of CSI resources with different CSI resource types under schemes in accordance with implementations of the present disclosure. Scenario 600 involves a network node (e.g., a macro base station and multiple micro base stations) and a UE, which may be a part of a wireless communication network (e.g., an LTE network, a 5G/NR network, an IoT network or a 6G network). Referring to FIG. 6, for AP-CSI resource, the signaling mechanism of the NZP CSI-RS resource or the CSI-IM resource may be that the NZP CSI-RS resource or the CSI-IM resource may be activated or deactivated through a CSI request within DCI format 0_1; and the signaling mechanism of the ZP CSI-RS resource may be activated or deactivated through a ZP CSI-RS trigger within DCI format 1_1. For SP-CSI resource, the signaling mechanism of the NZP CSI-RS resource or the CSI-IM resource may be that the NZP CSI-RS resource or the CSI-IM resource may be activated or deactivated through a MAC-CE; and the signaling mechanism of the ZP CSI-RS resource may be activated or deactivated through a MAC-CE. For P-CSI resource, the signaling mechanism of the NZP CSI-RS resource or the CSI-IM resource may be that the NZP CSI-RS resource or the CSI-IM resource may be activated or deactivated through a semi-static configuration (RRC signaling); and the signaling mechanism of the ZP CSI-RS resource may be activated or deactivated through semi-static configuration (RRC signaling).

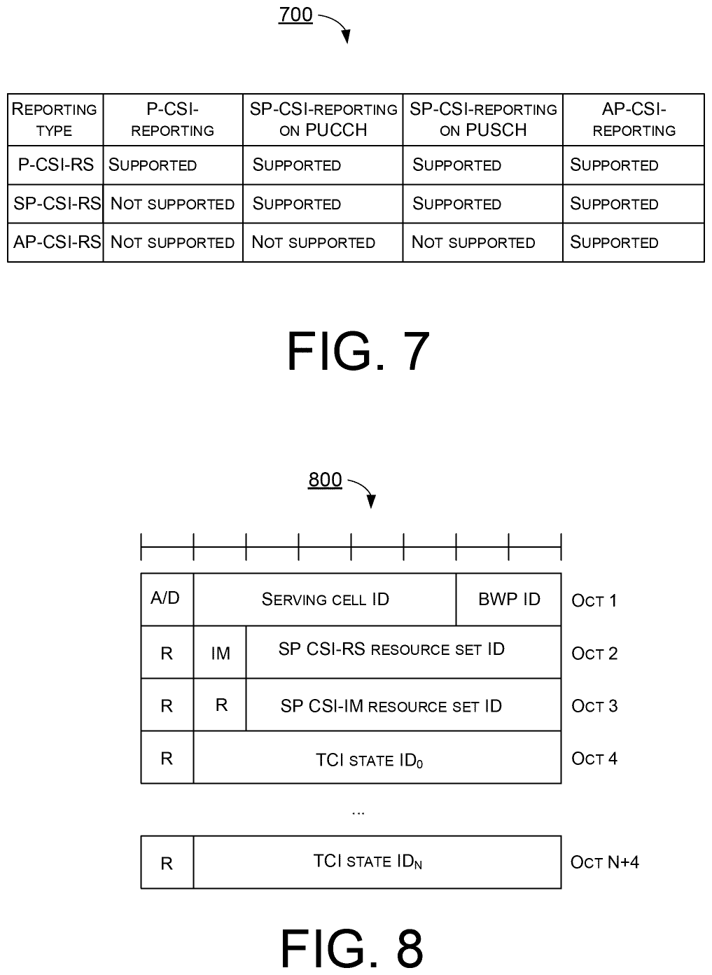

FIG. 7 illustrates an example scenario 700 of support status of CSI reporting types under schemes in accordance with implementations of the present disclosure. Scenario 700 involves a network node (e.g., a macro base station and multiple micro base stations) and a UE, which may be a part of a wireless communication network (e.g., an LTE network, a 5G/NR network, an IoT network or a 6G network). Referring to FIG. 7, for the P-CSI resource, the P-CSI resource may support the P-CSI reporting, the SP-CSI reporting on the PUCCH, the SP-CSI reporting on the PUSCH, and the AP-CSI reporting. For the SP-CSI resource, the SP-CSI resource may not support the P-CSI reporting and support the SP-CSI reporting on the PUCCH, the SP-CSI reporting on the PUSCH, and the AP-CSI reporting. For the AP-CSI resource, the SP-CSI resource may not support the P-CSI reporting, the SP-CSI reporting on the PUCCH and the SP-CSI reporting on the PUSCH, and support the AP-CSI reporting.

In some implementations, for the SP-CSI resources, the UE may receive a deactivation or activation of SP CSI-RS, SP CSI-IM, or SP ZP CSI-RS from the network node through a common DCI format or a MAC-CE. The MAC-CE may comprise a plurality of information blocks, e.g., Cell ID, BWP ID, CSI resource set ID, or CSI resource ID. The DCI format or MAC-CE may comprise a bit map to support the activations and deactivations among CSI resource sets or IDs within a single DCI format or MAC-CE command.

In some implementations, for the P-CSI resources, the UE may receive a deactivation and/or an activation of the P-CSI resource through a common DCI format or a MAC-CE. The MAC-CE may comprise multiple information blocks, Cell ID, BWP ID, CSI resource set ID, or CSI resource ID. The DCI format or MAC-CE may comprise a bit map to support the activations and deactivations among CSI resource sets or IDs within a single DCI format or MAC-CE command. If the UE receives the DCI format or MAC-CE for deactivation or activation of the P-CSI resources, the UE may suspend or skip the following P-CSI resources.

It may be assumed that the UE has an active semi-persistent CSI-RS/CSI-IM resource configuration or an active semi-persistent ZP CSI-RS resource set configuration and the UE has not received a deactivation command. In the implementation, when the corresponding DL BWP is active, the activated semi-persistent CSI-RS/CSI-IM resource set or the activated semi-persistent ZP CSI-RS resource set configurations may be active. Otherwise, the UE may determine to suspend the activated semi-persistent CSI-RS/CSI-IM resource set or the activated semi-persistent ZP CSI-RS resource set configurations.

If the UE is configured with carrier deactivation, the following configurations in the carrier in the activated state may also be deactivated and the UE may need to re-activate the configuration(s). The configurations may comprise at least one of the semi-persistent CSI-RS/CSI-IM resource, the semi-persistent CSI reporting on PUCCH, the semi-persistent SRS, and the semi-persistent ZP CSI-RS resource set.

FIG. 8 illustrates an example scenario 800 of a SP CSI-RS/CSI-IM resource set activation and deactivation MAC-CE under schemes in accordance with implementations of the present disclosure. Scenario 800 involves a network node (e.g., a macro base station and multiple micro base stations) and a UE, which may be a part of a wireless communication network (e.g., an LTE network, a 5G/NR network, an IoT network or a 6G network). Referring to FIG. 8, the SP CSI-RS/CSI-IM resource set activation and deactivation MAC-CE may comprise the reserved bits (R-fields), the activation/deactivation field (A/D), the IM field (IM), the Serving Cell ID field, the BWP ID field, the SP CSI-RS resource set ID field, the SP CSI-IM resource set ID field and TCI state ID fields (i.e., TCI state ID₀˜TCI state ID_{N}).

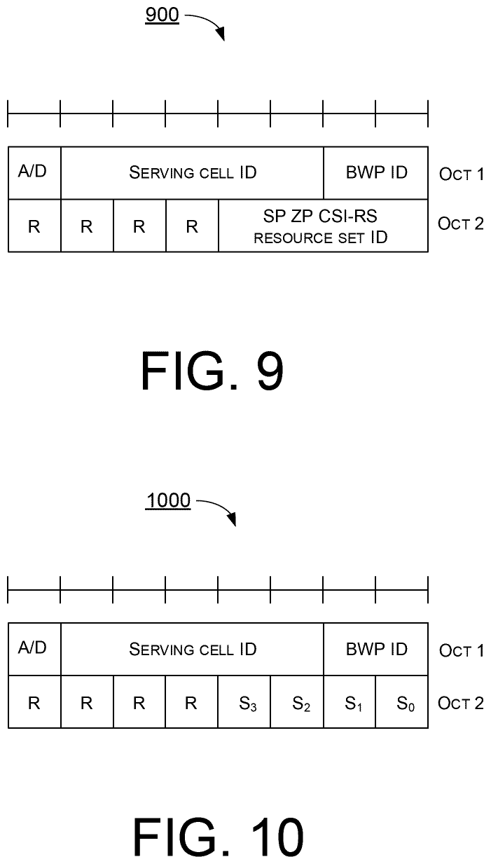

FIG. 9 illustrates an example scenario 900 of a SP ZP CSI-RS resource set activation and deactivation MAC-CE under schemes in accordance with implementations of the present disclosure. Scenario 900 involves a network node (e.g., a macro base station and multiple micro base stations) and a UE, which may be a part of a wireless communication network (e.g., an LTE network, a 5G/NR network, an IoT network or a 6G network). Referring to FIG. 9, the SP ZP CSI-RS resource set activation and deactivation MAC-CE may comprise the reserved bits (R-fields), the activation/deactivation field (A/D), the Serving Cell ID field, the BWP ID field and the SP ZP CSI-RS resource set ID field.

FIG. 10 illustrates an example scenario 1000 of a SP CSI reporting on PUCCH activation and deactivation MAC-CE under schemes in accordance with implementations of the present disclosure. Scenario 1000 involves a network node (e.g., a macro base station and multiple micro base stations) and a UE, which may be a part of a wireless communication network (e.g., an LTE network, a 5G/NR network, an IoT network or a 6G network). Referring to FIG. 10, the SP CSI reporting on PUCCH activation and deactivation MAC-CE may comprise the reserved bits (R-fields), the Serving Cell ID field, the BWP ID field and the Si field (i.e., S₃˜S₀) which indicates the activation/deactivation status.

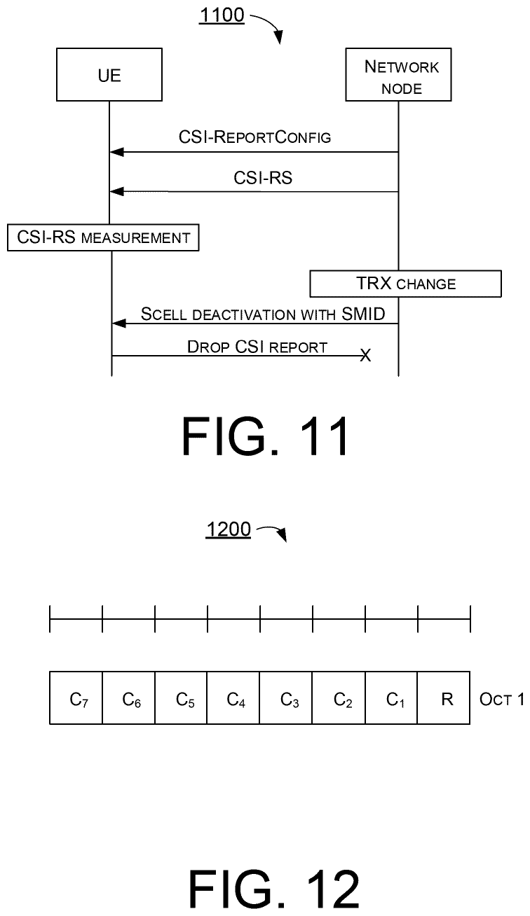

FIG. 11 illustrates an example scenario 1100 of an SCell activation and deactivation under schemes in accordance with implementations of the present disclosure. Scenario 1100 involves a network node (e.g., a macro base station and multiple micro base stations) and a UE, which may be a part of a wireless communication network (e.g., an LTE network, a 5G/NR network, an IoT network or a 6G network). Referring to FIG. 11, after a TRX change occurs in the network node, the UE may receive an indication associated with the SCell activation or deactivation (e.g., a sleep mode ID (SMID) associated with the SCell activation and deactivation). The MAC-CE in current technology may support a bit map to activate and deactivate multiple SCells via a single MAC-CE.

For example, the dual connectivity (DC) may allow a faster transition by reducing the need for handover to and from a small cell. In the example, turning off an SCell may still require around 80 milliseconds (ms) to 120 ms in LTE. The SCell on and off may require tens of milliseconds level.

In NR, the AP CSI-RS resources may be configured for the fast SCell activation. When the UE receives the SCell activation command in slot n, the UE may be capable of transmitting a valid CSI report and applying actions related to the activation command in slot n for the SCell which is activated no later than in slot n+T_HARQ+T_activationTime+T_CSIReporting, where T_HARQ (in ms) is the timing between DL data transmission and T_activationTime is the SCell activation delay in millisecond. The SCell activation delay may be determined based on whether SCell is known or unknown, the operation is on FR1 or FR2 band, and/or which types of CSI-RS are available.

In NR, in order to enable the fast SCell activation when carrier aggregation (CA) is configured, one dormant BWP may be configured for an SCell. It may be assumed that the active BWP of the activated SCell is a dormant BWP. In the implementation, the UE may stop monitoring the PDCCH and transmitting the SRS/PUSCH/PUCCH on the SCell, but the UE may continue performing the CSI measurements, the automatic gain control (AGC), and the beam management, if the dormant BWP is configured. A DCI may be used to determine whether to enter or leave the dormant BWP for one or more SCell(s) or one or more SCell group(s).

Although the fast SCell activation and deactivation have been supported, the SCell configuration may be still a semi-static configuration via RRC signaling. The UE may have to switch among different SCells to achieve dynamic TRX adaptation, e.g., the network node may configure SCell #0 with 32 TRX and SCell #1 with 16 TRX. The UE may switch between these SCells when a TRX change is needed.

In one implementation, the UE may receive a sleep mode ID (SMID) associated with the SCell activation and deactivation through the MAC-CE. The SMID may indicate a set of network energy saving (NWES) configurations, e.g., a CSI reporting, a CSI resource, an energy per resource element (EPRE), and a synchronization signal (SS)/physical broadcast channel (PBCH) block (SSB) measurement timing configuration (SMTC). The association may be indicated in a MAC-CE that has several SMID fields corresponding to the SCell that should be activated in ascending order of SCell index, or in a new DCI format that has several SMID fields, a SCell index, and a TRS index.

In another implementation, an SCell configuration may comprise a SMID that provides a set of NWES configurations, such as a bandwidth adaptation, a power adaptation, an antenna elements adaptation, and a discontinued time-domain operation. The UE may receive the SCell configuration and the SMID through the RRC messages, or activate one configuration from a pre-configured set through the MAC-CE commands.

FIG. 12 illustrates an example scenario 1200 of an SCell activation and deactivation MAC-CE of one octet under schemes in accordance with implementations of the present disclosure. Scenario 1200 involves a network node (e.g., a macro base station and multiple micro base stations) and a UE, which may be a part of a wireless communication network (e.g., an LTE network, a 5G/NR network, an IoT network or a 6G network). Referring to FIG. 12, the SCell activation and deactivation MAC-CE of one octet (i.e., October 1) may comprise a Cᵢ field (i.e., C-fields, C₇˜C₁) which indicates the activation and deactivation status of the SCell with the SCellIndex and the reserved bit (R-field).

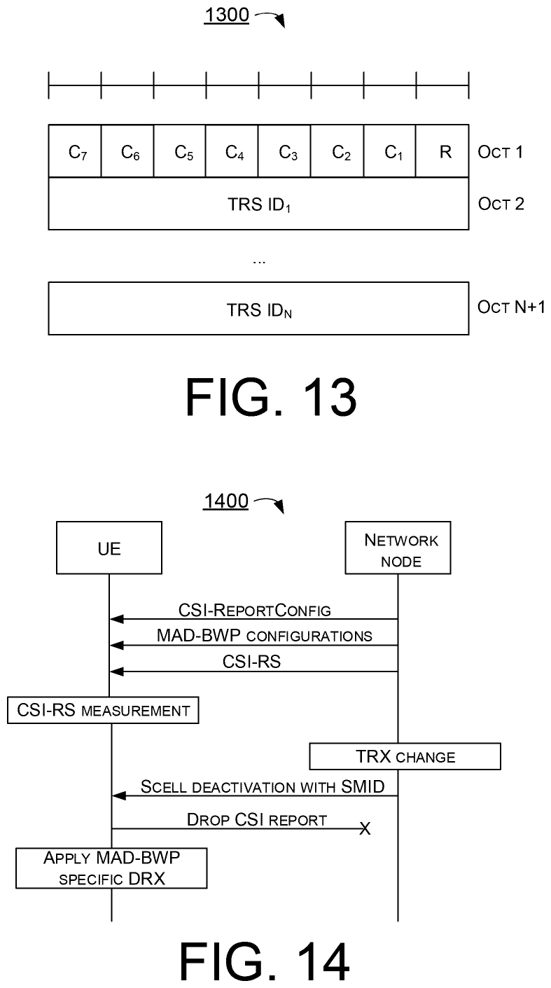

FIG. 13 illustrates an example scenario 1300 of a SCell activation and deactivation MAC-CE with one octet Cᵢ field under schemes in accordance with implementations of the present disclosure. Scenario 1300 involves a network node (e.g., a macro base station and multiple micro base stations) and a UE, which may be a part of a wireless communication network (e.g., an LTE network, a 5G/NR network, an IoT network or a 6G network). Referring to FIG. 13, the SCell activation and deactivation MAC-CE with one octet Cᵢ field may comprise a Cᵢ field (i.e., C-fields, C₇˜C₁) which indicates the activation and deactivation status of the SCell with the SCellIndex, the reserved bit (R-field), and TRS ID fields (i.e., TRS ID₁˜TRS ID_{N}).

FIG. 14 illustrates an example scenario 1400 of a BWP change with micro-active-dormant (MAD)-BWP ID under schemes in accordance with implementations of the present disclosure. Scenario 1400 involves a network node (e.g., a macro base station and multiple micro base stations) and a UE, which may be a part of a wireless communication network (e.g., an LTE network, a 5G/NR network, an IoT network or a 6G network). Referring to FIG. 14, the UE may receive Micro-Active Dormant BWP (MAD-BWP) configurations from the network node. The MAD-BWP configurations may comprise a MAD-BWP ID and a discontinuous reception (DRX) configuration. After a TRX change occurs in the network node, the UE may receive a BWP change indication based on the MAD-BWP configurations from the network node. The BWP change indication may be associated with the MAD-BWP ID. The UE may receive the BWP change indication from the network node through the DCI, RRC, timer, or event-triggered based manners. The UE may determine whether to drop a CSI report based on the BWP change indication. The UE may apply the specific DRX configuration in the MAD-BWP configurations.

After the BWP change, the UE may report a CSI report only when the UE receives at least one of a CSI-RS transmission occasion for channel measurement and a CSI-RS or CSI-IM occasion for interference measurement, and the CSI-RS or CSI-IM is not later than CSI reference resource. Otherwise, the UE may drop the CSI report.

After the BWP change, the associated CSI resource configuration may be changed accordingly. The associated CSI resource configuration may comprise the NZP-CSI-RS resources and DL power offsets. The DL power offsets may be used to configure DL power for the CSI-RS and the PDSCH.

The UE may receive the CSI-ResourceConfig that may comprise the NZP-CSI-RS-ResourceSet and the NZP-CSI-RS-Resource. The CSI-ResourceConfig may have bwp-Id, and the NZP-CSI-RS-Resource may have resourceMapping, powerControlOffset and powerControlOffsetSS. The powerControlOffsetSS information element (IE) may be configured through the RRC. The powerControlOffsetSS IE may indicate that the energy per resource element (EPRE) for the CSI-RS can be greater or less than the EPRE of the SSS. The powerControl Offset IE may be configured through the RRC. The positive values of the powerControlOffset IE may indicate that the PDSCH has a higher EPRE than the CSI-RS. The resourceMapping IE may have nrofPorts that provide the number of ports for CSI-RS.

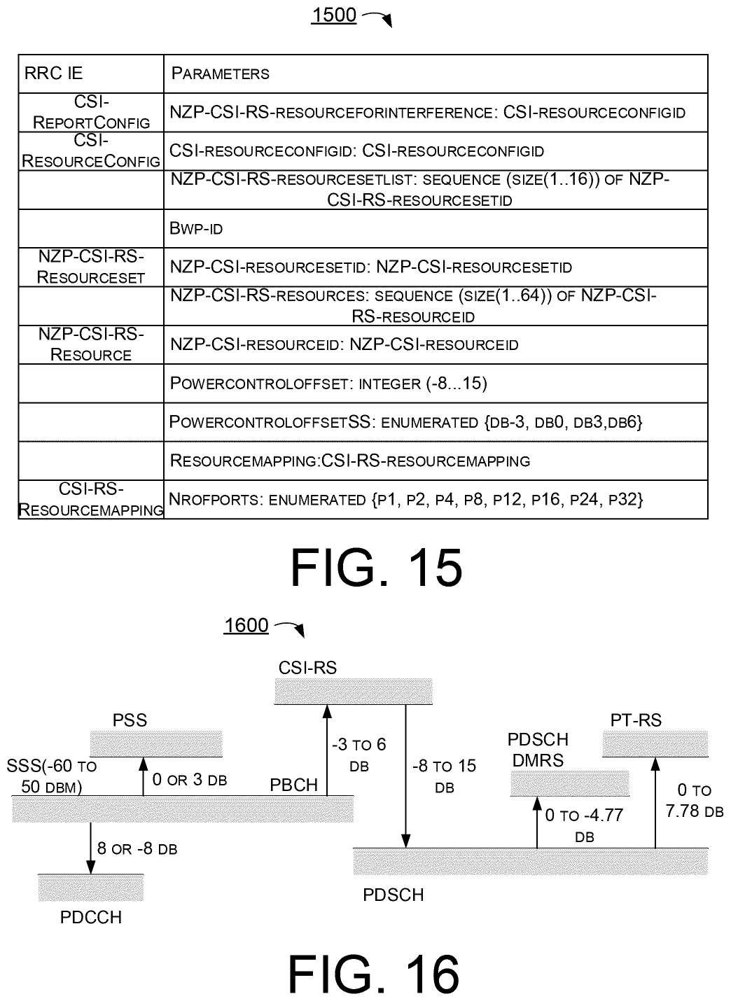

FIG. 15 illustrates an example scenario 1500 of RRC IEs under schemes in accordance with implementations of the present disclosure. Scenario 1500 involves a network node (e.g., a macro base station and multiple micro base stations) and a UE, which may be a part of a wireless communication network (e.g., an LTE network, a 5G/NR network, an IoT network or a 6G network). Referring to FIG. 15, the RRC IEs may comprise the CSI-ReportConfig IE, the CSI-ResourceConfig IE, the NZP-CSI-RS-ResourceSet IE, the NZP-CSI-RS-Resource IE, and the CSI-RS ResourceMapping IE. The CSI-ReportConfig IE may comprise the parameter of nzp-CSI-RS-ResourceForInterference. The CSI-ResourceConfig IE may comprise the parameters of cis-ResourceConfigId, nzp-CSI-RS-Resource SetList, ResourceSetId and bwp-Id. The NZP-CSI-RS-ResourceSet IE may comprise the parameters of nzp-CSI-ResourceSetId and nzp-CSI-Resources. The NZP-CSI-RS-Resource IE may comprise the parameters of nzp-CSI-ResourceSetId, powerControlOffset, powerControlOffsetSS, and resourceMapping. The CSI-RS ResourceMapping IE may comprise the parameter of nrofPorts.

FIG. 16 illustrates an example scenario 1600 of the powerContolOffsetSS and the powerContolOffset under schemes in accordance with implementations of the present disclosure. Scenario 1600 involves a network node (e.g., a macro base station and multiple micro base stations) and a UE, which may be a part of a wireless communication network (e.g., an LTE network, a 5G/NR network, an IoT network or a 6G network). Referring to FIG. 16, the powerContolOffsetSS may be −3 to 6 dB, and the powerContolOffset may be −8 to 15 dB.

If the UE changes to a dormant BWP, the UE may stop monitoring PDCCH on for the SCell, but the UE may continue performing the CSI measurements, AGC, and beam management, if the dormant BWP is configured.

For each serving cell other than the special cell (SpCell) (i.e., primary cell (PCell) or primary secondary cell (PScell)) or PUCCH SCell, the network node may configure one BWP as a dormant BWP.

If a UE is configured with a bwp-Inactivity Timer, the UE may switch back to the Default DL BWP after the inactivity timer has expired while using a non-Default DL BWP.

It is assumed that an active DL BWP provided by dormantBWP-Id for a UE on an activated SCell may be not a default DL BWP for the UE on the activated SCell. In the implementation, the BWP inactivity timer may be not used for the transition from the active DL BWP provided by dormantBWP-Id to the default DL BWP on the activated SCell.

If a BWP is activated and the active DL BWP for the Serving Cell is dormant BWP, the UE may perform at least one of the following operations. In an example, the UE may stop the bwp-Inactivity Timer of the Serving Cell, if the bwp-Inactivity Timer is running. In another example, the UE may not monitor the PDCCH on the BWP. In another example, the UE may not monitor the PDCCH for the BWP. In another example, the UE may not receive DL-SCH on the BWP. In another example, the UE may not report the CSI on the BWP, but report another CSI except aperiodic CSI for the BWP. In another example, the UE may not transmit the SRS on the BWP. In another example, the UE may not transmit on UL-SCH on the BWP. In another example, the UE may not transmit on RACH on the BWP. In another example, the UE may not transmit the PUCCH on the BWP. In another example, the UE may clear any configured downlink assignment and any configured uplink grant Type 2 associated with the SCell respectively. In another example, the UE may suspend any configured uplink grant Type 1 associated with the SCell. In another example, if the dormant BWP is configured, when beam failure is detected, the UE may perform beam failure detection and beam failure recovery for the SCell.

However, the NR may support only four DL or UL BWPs per carrier. Only a single BWP per carrier can be active in each direction. In the time division duplex (TDD), the UL and DL BWPs may share the same center frequency if they have the same bwp-Id. In carrier aggregation (CA), the NR may support a dormant BWP as one DL BWP configured by network node through the dedicated RRC signaling. If a TRX change requires a BWP change, four BWPs may be insufficient for TRX adaption. In addition, the dormant BWP may be applicable on SCells only. Extending the dormant BWP to PCell may need relaxation on the PDCCH monitoring mechanism.

Therefore, the UE may receive the MAD-BWP configurations from the network node. The MAD-BWP configurations may comprise the MAD-BWP ID and the discontinuous reception (DRX) configurations. It is may be assumed that an active DL BWP provided by MAD-BWP ID for a UE on an activated SCell or PCell is not a default DL BWP for the UE on the cell. In the implementation, the BWP inactivity timer may be not used for the transition from the active DL BWP provided by MAD-BWP ID to the default DL BWP on the cell.

If a BWP is activated and the active DL BWP for the Serving Cell is MAD-BWP and if the MAD-BWP configurations provide the DRX configurations, UE may follow the DRX configurations and perform at least one of the following operations. In an example, the UE may stop the bwp-Inactivity Timer of the Serving Cell, if the bwp-Inactivity Timer is running. In another example, the UE may not monitor the PDCCH on the BWP. In another example, the UE may not monitor the PDCCH for the BWP. In another example, the UE may not receive DL-SCH on the BWP. In another example, the UE may not report the CSI on the BWP, but report another CSI except aperiodic CSI for the BWP. In another example, the UE may not transmit the SRS on the BWP. In another example, the UE may not transmit on UL-SCH on the BWP. In another example, the UE may not transmit on RACH on the BWP. In another example, the UE may not transmit the PUCCH on the BWP. In another example, the UE may clear any configured downlink assignment and any configured uplink grant Type 2 associated with the SCell respectively. In another example, the UE may suspend any configured uplink grant Type 1 associated with the SCell. In another example, if the dormant BWP is configured, when beam failure is detected, the UE may perform beam failure detection and beam failure recovery for the SCell.

In some implementations, the dormant BWP configuration may provide a DRX configuration. If the DRX configuration is present, the dormant BWP may apply to PCell and SCell, and the UE may monitor the PDCCH based on the configured DRX configuration.

In some implementations, the dormant BWP configuration may provide the MAD-BWP configuration. If the MAD-BWP configuration is present, the UE may receive an indication through a DCI format to determine whether the UE should apply the dormant BWP configuration or the MAD-BWP configuration. The indication may indicate one or multiple MAD-BWP configurations by re-interpreting the existing fields in the DCI format. The UE may re-interpret the sequence of modulation and coding scheme fields, new data indicator, redundancy version, HARQ process number, antenna port(s), and DMRS sequence initialization in the DCI format to determine the bit indicating the MAD-BWP configuration.

In some implementations, the total BWP configured by the RRC may be extended to N, where 4 (up to 4) out of N BWP may be activated by a MAC-CE command, and 1 out of 4 BWP may be activated by a DCI format using the Bandwidth part indicator-0, 1 or 2 bits.

In some implementations, if the UE receives an SCell (or PCell) dormancy indication field that indicates one or multiple dormant DL BWPs, the UE may receive another dormancy level indication field that indicates one or multiple dormancy levels. The dormancy level indication may comprise the NWES adaptations in the time, frequency, spatial, and power domain. For example, a dormancy level 1 may comprise 16 max DL or UL antenna ports, 20 ms of DRX cycle, 48 RBs of DL or UL BWP, and 3 dB offset of EPRE for PDSCH. A dormancy level 2 may comprise 8 max DL or UL antenna ports, 40 ms of DRX cycle, 24 RBs of DL or UL BWP, and 0 dB offset of EPRE for PDSCH. The dormancy level indication may indicate multiple carrier components (CCs) to facilitate turning off common power consumption components, e.g., TxRU chains including radio frequency (RF) modules, power amplifiers (Pas), or analog-to-digital convertor (ADC), shared among CCs.

It may be assumed that the UE may receive a dormancy indication, a dormancy level indication, or a Micro-Active Dormant BWP indication. In the implementation, if the UE is able to parse and apply, the UE may transmit HARQ-ACK information to the network node through a configured HARQ codebook.

In some implementations, the UE configured with the DRX mode operation may be provided the following information (from the network node) for detecting a DCI format 2_6 in a PDCCH reception on the PCell or the SpCell.

In an example, the UE may be provided a PS-RNTI for DCI format 2_6 by ps-RNTI.

In another example, the UE may be provided the number of search space sets through the dci-Format 2-6 to monitor the PDCCH for the detection of DCI format 2_6 on the active DL BWP of the PCell or of the SpCell according to a common search space.

In another example, the UE may be provided a payload size for DCI format 2_6 through the size DCI-2-6.

In another example, when the UE is provided the number of groups of configured SCells by dormancyGroupOutsideActiveTime, the UE may be provided a bitmap indicated by the SCell dormancy indication field. The bitmap location may be immediately after the wake-up indication bit location. The bitmap size may be equal to the number of groups of configured SCells, and each bit of the bitmap may correspond to a group of configured SCells from the number of groups of configured SCells. A ‘0’ value for a bit of the bitmap may indicate an active DL BWP, provided by dormantBWP-Id, for the UE for each activated SCell in the corresponding group of configured SCells. In addition, a ‘I’ value for a bit of the bitmap may indicate an active DL BWP, provided by firstOutsideActiveTimeBWP-Id, for the UE for each activated SCell in the corresponding group of configured SCells, if a current active DL BWP is the dormant DL BWP, or indicate a current active DL BWP for the UE for each activated SCell in the corresponding group of configured SCells, if the current active DL BWP is not the dormant DL BWP. The UE may set the active DL BWP to the indicated active DL BWP.

In another example, the UE may be provided a bitmap indicated by the Micro-Activity Dormancy indication field. A ‘I’ value for a bit of the bitmap may indicate a MAD DL BWP associated with the SCell dormancy indication field, e.g., one-to-one mapping. In addition, a ‘0’ value for a bit of the bitmap may indicate a non-MAD DL BWP associated with the SCell dormancy indication field, e.g., one-to-one mapping.

In some implementations, if a UE is provided search space sets to monitor the PDCCH for detection of the DCI format 0_1 and the DCI format 1_1 and if one or both of the DCI format 0_1 and the DCI format 1_1 include an SCell dormancy indication field or a Micro-Activity Dormancy indication field, at least one of the following events may be met.

In an event, the SCell dormancy indication field may be a bitmap with a size which is equal to the number of groups of configured SCells provided by dormancy GroupWithinActiveTime.

In another event, each bit of the bitmap corresponds to a group of configured SCells from the number of groups of configured SCells.

In another event, if the UE detects a DCI format 0_1 or a DCI format 1_1 that does not include a carrier indicator field or detects a DCI format 0_1 or DCI format 1_1 that includes a carrier indicator field with a value equal to 0, and if the DCI format 0_1 does not indicate UL grant Type 2 release nor deactivate semi-persistent CSI report(s) on PUSCH, or if the DCI format 1_1 does not indicate SPS PDSCH release, at least one of the following settings may be met. In example, a ‘0’ value for a bit of the bitmap may indicate an active DL BWP, provided by dormantBWP-Id, for the UE for each activated SCell in the corresponding group of configured SCells. In another example, a ‘1’ value for a bit of the bitmap may indicate an active DL BWP, provided by firstWithinActiveTimeBWP-Id, for the UE for each activated SCell in the corresponding group of configured SCells, if a current active DL BWP is the dormant DL BWP, or indicate a current active DL BWP for the UE for each activated SCell in the corresponding group of configured SCells, if the current active DL BWP is not the dormant DL BWP. In another example, the UE may set the active DL BWP to the indicated active DL BWP.

In another event, the Micro-Activity Dormancy indication field may be a bitmap, where a ‘l’ value for a bit of the bitmap may indicate a MAD DL BWP associated with the SCell dormancy indication field, e.g., one-to-one mapping, and a ‘0’ value for a bit of the bitmap may indicate a non-MAD DL BWP associated with the SCell dormancy indication field, e.g., one-to-one mapping.

In some implementations, the SCell dormancy indication may comprise 0 bit if the higher layer parameter dormancyGroupOutsideActiveTime is not configured. Otherwise, SCell dormancy indication may comprise 1, 2, 3, 4 or 5 bits bitmap which is determined according to the number of different Dormancy GroupID(s) provided by higher layer parameter dormancyGroupOutsideActiveTime. Each bit may correspond to one of the SCell group(s) configured by higher layers parameter dormancyGroupOutsideActiveTime. The most significant bit (MSB) to the least significant bit (LSB) of the bitmap may correspond to the first to last configured SCell group in ascending order of DormancyGroupID.

In some implementations, the micro-activity dormancy indication may comprise 0 bit if the higher layer parameter dormancyGroupOutsideActiveTime is not configured. Otherwise, the micro-activity dormancy indication may comprise 1, 2, 3, 4 or 5 bits bitmap determined according to the number of different DormancyGroupID(s) provided by higher layer parameter dormancyGroupOutsideActiveTime. Each bit may correspond to one of the SCell group(s) configured by higher layers parameter dormancyGroupOutsideActiveTime. The MSB to LSB of the bitmap may correspond to the first to last configured SCell group in ascending order of Dormancy GroupID.

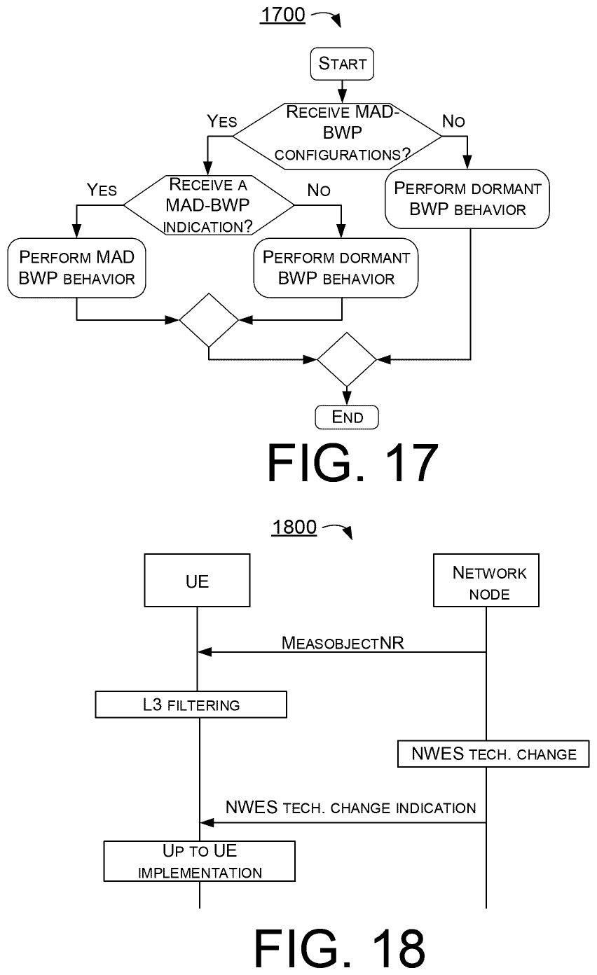

FIG. 17 illustrates an example scenario 1700 of a flow chart associated with the MAD BWP under schemes in accordance with implementations of the present disclosure. Scenario 1700 involves a network node (e.g., a macro base station and multiple micro base stations) and a UE, which may be a part of a wireless communication network (e.g., an LTE network, a 5G/NR network, an IoT network or a 6G network). Referring to FIG. 17, the UE may determine whether the MAD BWP configurations are received from the network node. If the UE receives the MAD BWP configurations from the network node, the UE may further determine whether a MAD BWP indication is received from the network node based on the MAD BWP configurations. If the UE receives the MAD BWP indication from the network node, the UE may perform the MAD BWP behavior based on the MAD BWP indication. If the UE does not receive the MAD BWP indication from the network node, the UE may perform the dormant BWP behavior.

A similar issue may be generating a cell level measurement from one or more beam level measurements. For CSI-RS measurements, the principles of the derivation may be the same as the cell level measurements, i.e., the following parameters may be used. In an example, the parameter may be the nrofCSI-RS-ResourcesToAverage, e.g., value ranges from 2 to 16. In another example, the parameter may be the abs ThreshCSI-RS-Consolidation, e.g., value ranges from 0 to 127.

The cell level measurement may be the linear average of the strongest measurement results that may exceed the threshold defined by absThreshCSI-RS-Consolidation. The strongest measurement results may comprise the maximum of nrofCSI-RS-ResourcesToAverage beams within the average.

The dedicated signaling may be used to configure the cell level measurements within specific Measurement Objects for measurement reporting and handovers.

If a TRX change occurs during the cell level measurement, the measurement result may become useless, and the UE may skip the corresponding CSI report for power saving. The network node may need to indicate the TRX change through the DCI or MAC-CE. Therefore, the present disclosure proposes some solutions to resolve the issues.

FIG. 18 illustrates an example scenario 1800 of a layer 3 filtering under schemes in accordance with implementations of the present disclosure. Scenario 1800 involves a network node (e.g., a macro base station and multiple micro base stations) and a UE, which may be a part of a wireless communication network (e.g., an LTE network, a 5G/NR network, an IoT network or a 6G network). Referring to FIG. 18, the UE may receive a MeasObjectNR from the network node. When the NWES technique change occurs in the network node. The network node may transmit the NWES technique change indication to the UE. The UE may determine whether to reset layer 3 filtering based on its implementation. That is, operations for the layer 3 filtering may be up to the UE implementation, e.g., whether the UE needs to reset filtering upon NWES techniques changes.

In some implementations, the layer 3 filtering may comprise at least one of the cell measurement quantity, the beam measurement quantity, the sidelink measurement quantity, the cross-link interference (CLI) measurement quantity, and the L2 UE-to-Network (U2N) Relay UE measurement quantity.

In some implementations, the UE implementation may comprise at least one of resetting filtering, dropping the corresponding measurement report, ignoring some of the previous measurement results, and ignoring any NWES techniques changes.

In some implementations, the NWES technique changes may comprise at least one of the BWP switch, TRX change, CSI (or SSB, or measurement) report (re) configuration, SCell (de) activation, SP-CSI (or SSB or other RS) de (activation), and SP-CSI (or SSB or other RS) (re) configuration. Another issue may occur when a UE is configured to receive the PDSCH with repetition. In the issue, the UE may receive repetitions of the downlink transport block (TB) across consecutive slots. There may be one repetition within each slot, and each repetition may use the same allocation of symbols.

The UE may receive an RRC IE pdsch-AggregationFactor, which defines the number of repetitions applied to the transmission of a downlink transport block on the PDSCH. When the aggregation factor is configured with a value of ‘n’, which is >1, the transport block transmission may be repeated in ‘n’ consecutive slots. The same symbol allocation may be assumed for all repetitions, and the PDSCH may be limited to a single layer. The redundancy version applied during the physical layer processing of the PDSCH may be changed for each repetition to help maximize the incremental redundancy combining gain at the UE receiver.

The UE may expect that the TB is repeated within each symbol allocation among each of the pdsch-AggregationFactor consecutive slots, and the PDSCH may be limited to a single transmission layer.

Each repetition may use a different redundancy version (RV) to provide an incremental redundancy (IR) gain during the soft combining procedure at the UE receiver. The use of different RVs may mean that different sets of bits are selected for transmission after channel coding.

If a TRX change happens during the PDSCH repetition, the UE may have skipped some of the PDSCH repetition when it performs the soft combining to decode the PDSCH. The network node may need to provide an indication through the DCI or MAC-CE. Therefore, the present disclosure proposes some solutions to resolve the issues.

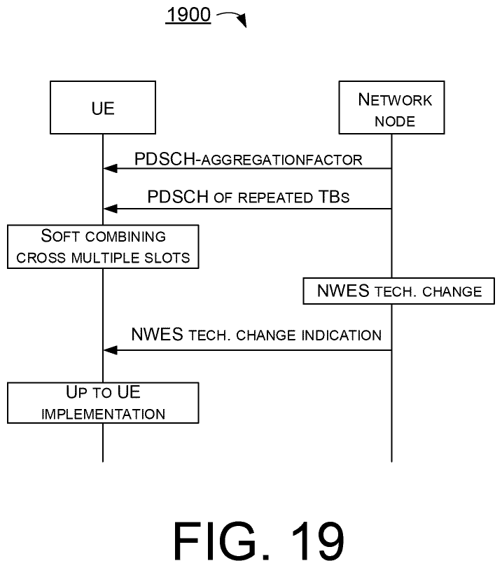

FIG. 19 illustrates an example scenario 1900 of a PDSCH repetition under schemes in accordance with implementations of the present disclosure. Scenario 1900 involves a network node (e.g., a macro base station and multiple micro base stations) and a UE, which may be a part of a wireless communication network (e.g., an LTE network, a 5G/NR network, an IoT network or a 6G network). Referring to FIG. 19, the UE may receive the PDSCH-AggregationFactor and the PDSCH repeated TBs from the network node. The UE may perform the soft combining procedure cross multiple of slots to decode the PDSCH. When the NWES technique change occurs in the network node, the network node may transmit the NWES technique change indication to the UE. When the UE receives the NWES technique change indication, the UE may determine whether to perform the soft combine and report the corresponding HARQ-ACK information to the network node. That is, the operations for the PDSCH repetition may be up to the UE implementation, e.g., whether the UE determine to perform the soft combine and report the corresponding HARQ-ACK information upon NWES techniques changes.

In some implementations, the UE implementation may comprise at least one of resetting soft combining, dropping the corresponding HARQ-ACK information and report, ignoring some of the previous PDSCH receptions, or ignoring any NWES techniques changes.

In some implementations, the NWES technique changes may comprise at least one of the BWP switch, the TRX change, the CSI (or SSB, or measurement) report (re) configuration, the SCell (de) activation, the SP-CSI (or SSB or other RS) de (activation), and the SP-CSI (or SSB or other RS) (re) configuration.

In some implementations, the implementation of FIG. 19 may be applied to a CSI-RS resource, PUSCH, and SRS with RRC parameters related to repetition or repeated transmission.

### Illustrative Implementations

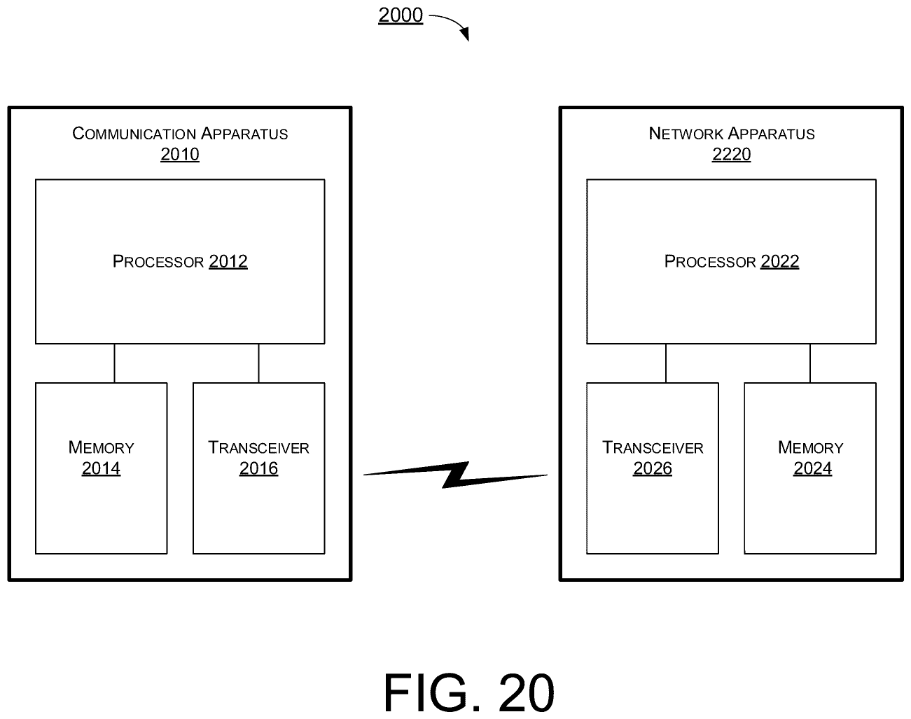

FIG. 20 illustrates an example communication system 2000 having an example communication apparatus 2010 and an example network apparatus 2020 in accordance with an implementation of the present disclosure. Each of communication apparatus 2010 and network apparatus 2020 may perform various functions to implement schemes, techniques, processes and methods described herein pertaining to the TRX adaptation with respect to user equipment and network apparatus in mobile communications, including scenarios/schemes described above as well as process 2100 described below.

Communication apparatus 2010 may be a part of an electronic apparatus, which may be a UE such as a portable or mobile apparatus, a wearable apparatus, a wireless communication apparatus or a computing apparatus. For instance, communication apparatus 2010 may be implemented in a smartphone, a smartwatch, a personal digital assistant, a digital camera, or a computing equipment such as a tablet computer, a laptop computer or a notebook computer. Communication apparatus 2010 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 2010 may be implemented in a smart thermostat, a smart fridge, a smart door lock, a wireless speaker or a home control center. Alternatively, communication apparatus 2010 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 2010 may include at least some of those components shown in FIG. 20 such as a processor 2012, for example. Communication apparatus 2010 may further include one or more other components not pertinent to the proposed scheme of the present disclosure (e.g., internal power supply, display device and/or user interface device), and, thus, such component(s) of communication apparatus 2010 are neither shown in FIG. 20 nor described below in the interest of simplicity and brevity.

Network apparatus 2020 may be a part of a network apparatus, which may be a network node such as a satellite, a base station, a small cell, a router or a gateway. For instance, network apparatus 2020 may be implemented in an eNodeB in an LTE network, in a gNB in a 5G/NR, IoT, NB-IoT or IIOT network or in a satellite or base station in a 6G network. Alternatively, network apparatus 2020 may be implemented in the form of one or more IC chips such as, for example and without limitation, one or more single-core processors, one or more multi-core processors, or one or more RISC or CISC processors. Network apparatus 2020 may include at least some of those components shown in FIG. 20 such as a processor 2022, for example. Network apparatus 2020 may further include one or more other components not pertinent to the proposed scheme of the present disclosure (e.g., internal power supply, display device and/or user interface device), and, thus, such component(s) of network apparatus 2020 are neither shown in FIG. 20 nor described below in the interest of simplicity and brevity.

In one aspect, each of processor 2012 and processor 2022 may be implemented in the form of one or more single-core processors, one or more multi-core processors, or one or more CISC processors. That is, even though a singular term “a processor” is used herein to refer to processor 2012 and processor 2022, each of processor 2012 and processor 2022 may include multiple processors in some implementations and a single processor in other implementations in accordance with the present disclosure. In another aspect, each of processor 2012 and processor 2022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 2012 and processor 2022 is a special-purpose machine specifically designed, arranged and configured to perform specific tasks including autonomous reliability enhancements in a device (e.g., as represented by communication apparatus 2010) and a network (e.g., as represented by network apparatus 2020) in accordance with various implementations of the present disclosure.

In some implementations, communication apparatus 2010 may also include a transceiver 2016 coupled to processor 2012 and capable of wirelessly transmitting and receiving data. In some implementations, communication apparatus 2010 may further include a memory 2014 coupled to processor 2012 and capable of being accessed by processor 2012 and storing data therein. In some implementations, network apparatus 2020 may also include a transceiver 2026 coupled to processor 2022 and capable of wirelessly transmitting and receiving data. In some implementations, network apparatus 2020 may further include a memory 2024 coupled to processor 2022 and capable of being accessed by processor 2022 and storing data therein. Accordingly, communication apparatus 2010 and network apparatus 2020 may wirelessly communicate with each other via transceiver 2016 and transceiver 2026, respectively. To aid better understanding, the following description of the operations, functionalities and capabilities of each of communication apparatus 2010 and network apparatus 2020 is provided in the context of a mobile communication environment in which communication apparatus 2010 is implemented in or as a communication apparatus or a UE and network apparatus 2020 is implemented in or as a network node of a communication network.

In some implementations, processor 2012 may receive, via transceiver 2016, an indication of spatial element adaptation from network apparatus 2020. Processor 2012 may determine whether to transmit a CSI-RS report based on the indication of spatial element adaptation.

In some implementations, processor 2012 may receive, via transceiver 2016, the indication from network apparatus 2020 through a RRC signaling, a MAC-CE, or a DCI.

In some implementations, processor 2012 may adapt or reconfigure a configured CSI-RS configuration according to the indication. The adapting or reconfiguring may comprise dynamic or semi-persistent on or off of a CSI-RS, or adapted number of spatial elements or ports.

In some implementations, the indication of spatial element adaptation may comprise at least one of an information field, a plurality of information blocks, a cell ID, a BWP ID, a TRX configuration ID, a CSI report configuration ID, a CSI resource configuration ID, a CSI-RS configuration and a CSI-RS reconfiguration.

In some implementations, the indication of spatial element adaptation may comprise at least one of a CSI-RS resource, a CSI-RS resource set and a CSI-RS resource setting, and wherein the at least one of the CSI-RS resource, the CSI-RS resource set and the CSI-RS resource setting associates with one or more spatial adaptation patterns.

In some implementations, the spatial adaptation pattern may comprise a set of parameters which determine a spatial element adaptation, and wherein the set of parameters comprises at least one of spatial domain parameters, spectral domain parameters, and temporal domain parameters.

In some implementations, a spatial element indicated by the indication of spatial element adaptation may comprise at least one of an antenna element, a transceiver unit (TxRU), an antenna panel, and a logical antenna port.

In some implementations, the indication of spatial element adaptation may comprise a CSI report configuration, and wherein the CSI report configuration associates with one or more spatial adaptation patterns.

In some implementations, the indication of spatial element adaptation may comprise a plurality of CSI report sub-configurations, and wherein each CSI report sub-configurations associates with one spatial adaptation pattern.

### Illustrative Processes

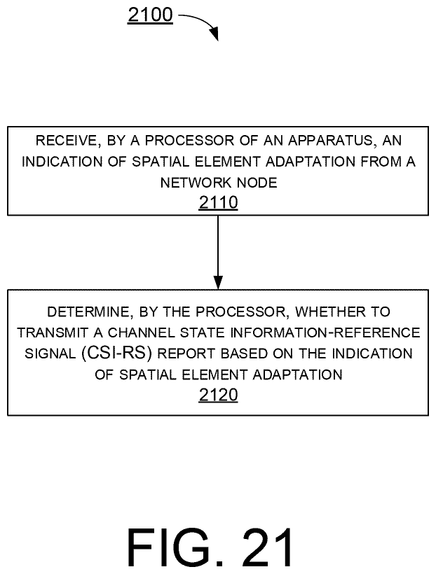

FIG. 21 illustrates an example process 2100 in accordance with an implementation of the present disclosure. Process 2100 may be an example implementation of above scenarios/schemes, whether partially or completely, with respect to network power saving with the present disclosure. Process 2100 may represent an aspect of implementation of features of communication apparatus 2010. Process 2100 may include one or more operations, actions, or functions as illustrated by one or more of blocks 2110 and 2120. Although illustrated as discrete blocks, various blocks of process 2100 may be divided into additional blocks, combined into fewer blocks, or eliminated, depending on the desired implementation. Moreover, the blocks of process 2100 may be executed in the order shown in FIG. 21 or, alternatively, in a different order. Process 2100 may be implemented by communication apparatus 2010 or any suitable UE or machine type devices. Solely for illustrative purposes and without limitation, process 2100 is described below in the context of communication apparatus 2010. Process 2100 may begin at block 2110.

At 2110, process 2100 may involve processor 2012 of communication apparatus 2010 receiving an indication of spatial element adaptation from a network node. Process 2100 may proceed from 2110 to 2120.

At 2120, process 2100 may involve processor 2012 determining whether to transmit a CSI-RS report based on the indication of spatial element adaptation.

In some implementations, process 2100 may involve processor 2012 receiving the indication from the network node through a RRC signaling, a MAC-CE, or a DCI.

In some implementations, process 2100 may involve processor 2012 adapting or reconfiguring a configured CSI-RS configuration according to the indication.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, an indication of spatial element adaptation from a network node; and
determining, by the processor, whether to transmit a channel state information-reference signal (CSI-RS) report based on the indication of spatial element adaptation.

2. The method of claim 1, the receiving of the indication of spatial element adaptation comprises:
receiving, by the processor, the indication from the network node through a radio resource control (RRC) signaling, a media access control (MAC) control element (MAC-CE), or a downlink control information (DCI).

3. The method of claim 1, further comprises:
adapting or reconfiguring, by the processor, a configured CSI-RS configuration according to the indication.

4. The method of claim 3, wherein the adapting or reconfiguring comprises dynamic or semi-persistent on or off of a CSI-RS, or adapted number of spatial elements or ports.

5. The method of claim 1, wherein the indication of spatial element adaptation comprises at least one of an information field, a plurality of information blocks, a cell identity (ID), a bandwidth part (BWP) ID, a transceiver (TRX) configuration ID, a CSI report configuration ID, a CSI resource configuration ID, a CSI-RS configuration and a CSI-RS reconfiguration.

6. The method of claim 1, wherein the indication of spatial element adaptation comprises at least one of a CSI-RS resource, a CSI-RS resource set and a CSI-RS resource setting, and wherein the at least one of the CSI-RS resource, the CSI-RS resource set and the CSI-RS resource setting associates with one or more spatial adaptation patterns.

7. The method of claim 6, wherein the spatial adaptation pattern comprises a set of parameters which determine a spatial element adaptation, and wherein the set of parameters comprises at least one of spatial domain parameters, spectral domain parameters, and temporal domain parameters.

8. The method of claim 1, wherein a spatial element indicated by the indication of spatial element adaptation comprises at least one of an antenna element, a transceiver unit (TxRU), an antenna panel, and a logical antenna port.

9. The method of claim 1, wherein the indication of spatial element adaptation comprises a CSI report configuration, and wherein the CSI report configuration associates with one or more spatial adaptation patterns.

10. The method of claim 1, wherein the indication of spatial element adaptation comprises a plurality of CSI report sub-configurations, and wherein each CSI report sub-configurations associates with one spatial adaptation pattern.

11. An apparatus, comprising:
a transceiver which, during operation, wirelessly communicates with at least one network node; and
a processor communicatively coupled to the transceiver such that, during operation, the processor performs operations comprising:
receiving, via the transceiver, an indication of spatial element adaptation from the network node; and
determining whether to transmit a channel state information-reference signal (CSI-RS) report based on the indication of spatial element adaptation.

12. The apparatus of claim 11, wherein, in receiving the indication of spatial element adaptation, the processor receives, via the transceiver, the indication from the network node through a radio resource control (RRC) signaling, a media access control (MAC) control element (MAC-CE), or a downlink control information (DCI).

13. The apparatus of claim 11, wherein, during operation, the processor further performs operations comprising:
adapting or reconfiguring, by the processor, a configured CSI-RS configuration according to the indication.

14. The apparatus of claim 13, wherein the adapting or reconfiguring comprises dynamic or semi-persistent on or off of a CSI-RS, or adapted number of spatial elements or ports.

15. The apparatus of claim 11, wherein the indication of spatial element adaptation comprises at least one of an information field, a plurality of information blocks, a cell identity (ID), a bandwidth part (BWP) ID, a transceiver (TRX) configuration ID, a CSI report configuration ID, a CSI resource configuration ID, a CSI-RS configuration and a CSI-RS reconfiguration.

16. The apparatus of claim 11, wherein the indication of spatial element adaptation comprises at least one of a CSI-RS resource, a CSI-RS resource set and a CSI-RS resource setting, and wherein the at least one of the CSI-RS resource, the CSI-RS resource set and the CSI-RS resource setting associates with one or more spatial adaptation patterns.

17. The apparatus of claim 16, wherein the spatial adaptation pattern comprises a set of parameters which determine a spatial element adaptation, and wherein the set of parameters comprises at least one of spatial domain parameters, spectral domain parameters, and temporal domain parameters.

18. The apparatus of claim 11, wherein a spatial element indicated by the indication of spatial element adaptation comprises at least one of an antenna element, a transceiver unit (TxRU), an antenna panel, and a logical antenna port.

19. The apparatus of claim 11, wherein the indication of spatial element adaptation comprises a CSI report configuration, and wherein the CSI report configuration associates with one or more spatial adaptation patterns.

20. The apparatus of claim 11, wherein the indication of spatial element adaptation comprises a plurality of CSI report sub-configurations, and wherein each CSI report sub-configurations associates with one spatial adaptation pattern.
